(19) United States
(12) Patent Application Publication
(10) Pub. No.: US 2025/0209722 A1
(43) Pub. Date: Jun. 26, 2025

(54) METHOD, MEDIUM, AND DEVICE FOR GENERATING CLOTHING FOR A VIRTUAL CHARACTER

(71) Applicant: Beijing Zitiao Network Technology Co., Ltd., Beijing (CN)

(72) Inventors: Shen ZHENG, Beijing (CN); Zhilin QIU, Beijing (CN); Tianyang SHI, Beijing (CN); Li ZHONG, Beijing (CN); Lusheng LIN, Beijing (CN); Jingheng ZHANG, Beijing (CN)

(21) Appl. No.: 18/917,671

(22) Filed: Oct. 16, 2024

(30) Foreign Application Priority Data
Dec. 22, 2023 (CN) 202311792356.9

(51) Int. Cl. G06T 15/04; G06T 11/00

(52) U.S. Cl. CPC G06T 15/04; G06T 11/00

(57) ABSTRACT

The present disclosure provides a method, a medium, and a device for generating clothing for a virtual character. The method includes: receiving a target picture, and determining clothing feature prompt information corresponding to the target picture; generating an initial clothing image corresponding to a virtual character based on the target picture; generating a target clothing image corresponding to the virtual character based on the initial clothing image and the clothing feature prompt information; and determining a target UV map of a target clothing corresponding to the virtual character based on the target clothing image, where the target UV map is used to render the clothing for the virtual character.

### CROSS-REFERENCE TO RELATED APPLICATION

This application claims the priority to and benefits of the Chinese Patent Application No. 202311792356.9, which was filed on Dec. 22, 2023. All the aforementioned patent applications are hereby incorporated by reference in their entireties.

### TECHNICAL FIELD

The present disclosure relates to the field of computer technologies, and in particular, to a method, a medium, and a device for generating clothing for a virtual character.

BACKGROUND

Currently, a lot of clients can render an obtained virtual environment by installing an application. The virtual environment may include a virtual character, which may be presented as a person, a cartoon character, or the like.

During a user interaction process, the user can change clothing for the virtual character, so that a corresponding outfit for the virtual character can be provided based on a user interaction operation. In the related art, the user usually selects clothing from articles of clothing that are configured in a clothing library of the application for matching and changing. However, in the above manner, the number of articles of clothing that can be applied is limited, and the generation of clothing needs to be configured in advance, so that it is difficult to meet requirements for diversified display.

SUMMARY

The Summary is to introduce the concepts in a simplified form, and the concepts will be described in detail later in the detailed description. The Summary is neither intended to identify the key or necessary features of the claimed technical solutions, nor is it intended to be used to limit the scope of the claimed technical solutions.

According to a first aspect, the present disclosure provides a method for generating clothing for a virtual character, the method including:
receiving a target picture, and determining clothing feature prompt information corresponding to the target picture;
generating an initial clothing image corresponding to a virtual character based on the target picture;
generating a target clothing image corresponding to the virtual character based on the initial clothing image and the clothing feature prompt information; and
determining a target UV map of a target clothing corresponding to the virtual character based on the target clothing image, wherein the target UV map is used to render the clothing for the virtual character.

According to a second aspect, the present disclosure provides an apparatus for generating clothing for a virtual character, the apparatus including:
a first determining module, configured to receive a target picture, and determine clothing feature prompt information corresponding to the target picture;
a first generation module, configured to generate an initial clothing image corresponding to a virtual character based on the target picture;
a second generation module, configured to generate a target clothing image corresponding to the virtual character based on the initial clothing image and the clothing feature prompt information; and
a second determining module, configured to determine a target UV map of a target clothing corresponding to the virtual character based on the target clothing image, wherein the target UV map is used to render the clothing for the virtual character.

According to a third aspect, the present disclosure provides a non-transitory computer-readable medium having stored thereon a computer program that, when executed by a processor, causes steps of the method according to the first aspect to be implemented.

According to a fourth aspect, the present disclosure provides an electronic device, including:
a memory having stored thereon a computer program; and
a processor configured to execute the computer program in the memory to implement steps of the method according to the first aspect.

### BRIEF DESCRIPTION OF DRAWINGS

The above and other features, advantages, and aspects of embodiments of the present disclosure will become more apparent with reference to the following detailed description in conjunction with the accompanying drawings. Throughout the drawings, the same or similar reference numbers denote the same or similar elements. It should be understood that the drawings are schematic, and parts and elements are not necessarily drawn to scale. In the drawings:

FIG. 1 is a flowchart of a method for generating clothing for a virtual character according to an embodiment of the present disclosure;

FIG. 2 is a schematic diagram of a target clothing template according to an embodiment of the present disclosure;

FIG. 3 is a block diagram of an apparatus for generating clothing for a virtual character according to an embodiment of the present disclosure; and

FIG. 4 is a structural schematic diagram of an electronic device suitable for implementing the embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for illustrative purposes and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this regard.

The term “include/comprise” used herein and the variations thereof are an open-ended inclusion, that is, “include/comprise but not limited to”. The term “based on” means “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that the concepts such as “first,” “second,” etc. mentioned in the present disclosure are only used to distinguish different apparatuses, modules, or units, and are not intended to limit orders or interdependence relationships of functions performed by these apparatuses, modules, or units.

It should be noted that modifications of “one” and “more” mentioned in the present disclosure are schematic rather than restrictive, and those skilled in the art should understand that otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the user should be informed of the types, scope of use, and use scenarios of personal information involved in the present disclosure in an appropriate manner in accordance with relevant laws and regulations, and the user's authorization should be obtained.

For example, when a user actively requests, a prompt message is sent to the user to explicitly prompt the user that the operation requested by the user will need to acquire and use the user's personal information. Therefore, the user can independently choose whether to provide personal information to software or hardware such as an electronic device, an application, a server, or a storage medium that executes an operation of the technical solution of the present disclosure according to the prompt message.

As an optional but non-limiting implementation, for example, in response to receiving an active request from the user, the prompt message may be sent to the user in a pop-up window, and the prompt message may be presented in text in the pop-up window. In addition, the pop-up window may also carry a selection control for the user to select “agree” or “disagree” to provide personal information to the electronic device.

It may be understood that the above process of notifying and obtaining user authorization is only illustrative and does not limit the implementation of the present disclosure. Other manners that meet relevant laws and regulations may also be applied to the implementation of the present disclosure.

At the same time, it may be understood that the data involved in the technical solution of the present disclosure (including but not limited to the data itself, the acquisition or use of the data) should comply with the requirements of corresponding laws, regulations, and related regulations.

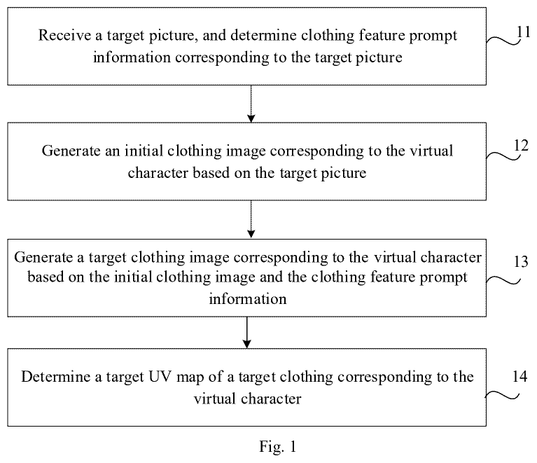

FIG. 1 is a flowchart of a method for generating clothing for a virtual character according to an embodiment of the present disclosure. As shown in FIG. 1, the method includes:

In step 11, a target picture is received, and clothing feature prompt information corresponding to the target picture is determined.

The target picture may be a picture uploaded by a user for generating clothing. The target picture may include a clothing image, and clothing may be generated for the virtual character based on the clothing image included therein. If the target picture does not include a clothing image, clothing may be generated for the virtual character based on feature elements in the target picture. For example, during a picture browsing process, the user finds a clothing picture that is of interest to the user. The user may download or screenshot the picture, and then upload the obtained picture to configure a corresponding clothing on the virtual character.

In this step, the clothing feature prompt information is used to represent a set of prompts extracted from the target picture for generating the clothing, and is used to represent display information of a target clothing, such as a color and a pattern of the target clothing. For example, a plurality of clothing dimensions may be preset, so that feature extraction may be performed based on each clothing dimension to obtain the clothing feature prompt information, thereby providing data for subsequent clothing generation.

In step 12, an initial clothing image corresponding to the virtual character is generated based on the target picture.

The initial clothing image may be a preview image for rendering, for the virtual character, clothing corresponding to the target picture. In this step, features in the target picture may be mapped to a clothing area corresponding to the virtual character, to obtain the initial clothing image.

In step 13, a target clothing image corresponding to the virtual character is generated based on the initial clothing image and the clothing feature prompt information.

For example, the initial clothing image and the clothing feature prompt information may be inputted into a pre-trained image processing model for image generation, so as to perform secondary adjustment on the initial clothing image based on the clothing feature prompt information, thereby improving the matching degree between the target clothing image and the target picture.

The image processing model may be a model implemented based on an AI (Artificial Intelligence) drawing algorithm, and image generation may be performed through a Diffusion Model or Stable Diffusion, for example. The diffusion model may be trained based on a general training manner in the art, which is not limited in the present disclosure.

In step 14, a target UV map of a target clothing corresponding to the virtual character is determined based on the target clothing image, where the target UV map is used to render the clothing for the virtual character.

The target clothing image is a two-dimensional image. Back projection processing may be performed based on a three-dimensional structure of the virtual character, to map the two-dimensional image to a three-dimensional clothing surface of the virtual character, thereby obtaining the target UV map. In a client, rendering may be performed based on a UV map rendering manner in the art, so that the target UV map can be rendered on a virtual clothing corresponding to the virtual character, to implement generation of the clothing for the virtual character.

In the above technical solution, when matching clothing for the virtual character, the user can upload the picture, so that a clothing UV map consistent with the features of the uploaded picture can be generated for the virtual character, to render the clothing for the virtual character, thereby implementing generating clothing from the content of the target picture for display on the virtual character, and implementing the customized clothing change for the virtual character. Therefore, through the above technical solution, an automatic clothing change for the virtual character may be implemented directly based on the target picture uploaded by the user, without relying on a plurality of predefined articles of clothing preset in a database, thereby reducing the manual workload required for generating the predefined articles of clothing. In addition, the user only needs to upload the picture to configure, for the virtual character, clothing consistent with the picture. Through the picture, the features of the clothing that the user wants to generate can be expressed more intuitively, so that the generated target clothing better matches the user requirements. In addition, while the personalization and customization of the clothing for the virtual character are supported, the user does not need to describe the clothing, thereby simplifying the user operation process and avoiding the occurrence of a situation in which the generated clothing does not match the user requirements due to the user's description error, thereby improving the user's satisfaction with the generated clothing, effectively expanding the scope of application of the method for generating the clothing for the virtual character, and improving the user experience.

In a possible embodiment, an example implementation of the determining clothing feature prompt information corresponding to the target picture may include:
detecting the target picture to determine a clothing detection result corresponding to the target picture, where the clothing detection result includes a clothing detection box in the target picture and a clothing attribute.

For example, detection may be performed based on a clothing classification model, to obtain the clothing detection result. For example, training data may be obtained based on marking clothing positions and clothing attributes in open-source images, to train the clothing classification model based on the training data. Then the target picture may be inputted into the trained clothing classification model, so that a regional position of the clothing in the target picture and a clothing attribute of the clothing can be obtained. As another example, the clothing attribute may be recognized based on a CLIP (Contrastive Language-Image Pre-Training) model, and the CLIP model is a pre-trained neural network model for matching an image and text. A classification corresponding to the clothing attribute may be preset, for example, 7 categories may be obtained at a coarse granularity, which may include a long sleeve, a short sleeve, and the like, and then fine-grained division may be performed for each category, for example, a long-sleeved category may include a jacket, a windbreaker, a down jacket, and the like. The classification may be set based on an actual application scenario, which is not limited in the present disclosure.

Then, a prompt corresponding to the target picture is generated based on the clothing detection result and the target picture, and the clothing feature prompt information is generated based on the prompt.

For example, text obtained by splicing various prompts may be used as the clothing feature prompt information.

For example, a manner of generating a prompt corresponding to the target picture based on the clothing detection result and the target picture may include:
performing feature extraction on the target picture based on a clothing description model to obtain a clothing description text corresponding to the target picture. The clothing description model may be implemented based on a large language model, for example, a llava model. The target picture is inputted into the clothing description model, to obtain a description text of the clothing in the target picture. The description text may be a corresponding natural language description.

A prompt corresponding to each clothing feature dimension is determined based on the clothing description text and a preset clothing feature dimension. The clothing feature dimension includes the clothing attribute.

The clothing attribute may be one or more, for example, may include a clothing style, a material, and the like. The clothing feature dimension may be configured based on an actual application scenario. For example, in addition to the clothing attribute, the clothing feature dimension may also include dimensions such as a color, a pattern detail, and an accessory. In this embodiment, feature extraction may be performed from different clothing feature dimensions based on the clothing description text, to obtain a prompt with formatted representation.

If the clothing detection result is empty, it indicates that no clothing image is detected in the target picture. In this case, the clothing feature prompt information may be directly generated based on the prompt corresponding to the clothing feature dimension.

Then, in response to a confidence level corresponding to the clothing attribute in the clothing detection result being greater than or equal to a confidence level threshold, the prompt corresponding to the clothing attribute is updated to an attribute value of the clothing attribute in the clothing detection result. The confidence level threshold may be set based on an actual application scenario, which is not limited in the present disclosure.

Based on the above, it can be seen that, a corresponding value of the clothing attribute may be determined based on the clothing description text and the clothing detection result. If the determined values of the clothing attribute are different and the confidence level corresponding to the clothing attribute in the clothing detection result is greater than or equal to the confidence level threshold, it is considered that the clothing attribute in the clothing detection result is accurate. In this case, the prompt corresponding to the clothing attribute may be updated to the attribute value of the clothing attribute in the clothing detection result.

For example, a prompt of a clothing attribute determined based on the clothing description text is a cotton jacket, and the clothing attribute in the clothing detection result is a down jacket, and a confidence level corresponding to the down jacket is greater than the confidence level threshold. In this case, the prompt of the clothing attribute may be updated to a down jacket. Therefore, the clothing feature prompt information may be secondarily extracted based on the clothing attribute in the clothing detection result, to ensure the accuracy of the determined clothing feature prompt information and provide accurate data support for subsequent clothing generation.

In a possible embodiment, an example implementation of the generating an initial clothing image corresponding to a virtual character based on the target picture may include:
generating a front-view clothing image corresponding to the virtual character based on the target picture and a target clothing template corresponding to the virtual character. The front-view clothing image may be used to represent a clothing image displayed when a face of the virtual character is facing a screen.

The target clothing template is used to represent a clothing type of the virtual character. For example, the target clothing template may include an upper clothing template and a lower clothing template. For example, the upper clothing template is a long-sleeved template, and the lower clothing template is a long-pants template. Then a long-sleeved clothing and long-pants clothing corresponding to the virtual character may be generated based on content features in the target picture.

For example, the target clothing template may be a preset template corresponding to the virtual character. As another example, a plurality of clothing templates may be output and displayed, and a clothing template selected by a selection operation is used as the target clothing template in response to the selection operation of a user. For example, if the user selects a short-sleeved template and a short-skirt template, the short-sleeved template and the short-skirt template may be used as the target clothing template, to generate a short-sleeved clothing and a short-skirt clothing corresponding to the virtual character based on content features in the target picture.

Then, a back-view clothing image corresponding to the virtual character is generated based on the front-view clothing image and a preset image generation model. The initial clothing image includes the front-view clothing image and the back-view clothing image. The back-view clothing image may be used to represent a clothing image displayed when a back of the virtual character is facing a screen.

For example, a large amount of clothing images may be obtained in advance. If a set of training images can be obtained through projection on a front side and a back side of clothing, the training images may include a front view and a back view of the clothing image. During training, the front view may be used as a model input, the back view may be used as a target output of the model, and model training is performed. The training manner may be determined based on a general model training manner in the art, which is not elaborated herein.

In this embodiment, the front-view clothing image may be inputted into the image generation model for image generation, to obtain the back-view clothing image corresponding to the front-view clothing image. Through the above technical solution, the back-view clothing image may be generated based on the front-view clothing image, thereby avoiding the problem of inconsistency between a color and a texture of the back-view clothing image and those of the front-view clothing image when the front-view clothing image and the back-view clothing image are generated separately, thereby ensuring the consistency of the generated clothing image on the back and front, and improving the accuracy and smoothness of the clothing image.

In a possible embodiment, the generating a front-view clothing image corresponding to the virtual character based on the target picture and a target clothing template corresponding to the virtual character may include:
in a case that there is a clothing image in the target picture, performing a clothing key point detection based on the target clothing template and the target picture to determine a clothing key point corresponding to the clothing image.

Each target clothing template is pre-labeled with a corresponding clothing key point sequence. Taking the target clothing template as a long-sleeved template as an example, 33 key points may be configured and labeled respectively, as shown in FIG. 2. In this step, after it is determined that there is a clothing image in the target picture, 33 corresponding key points may be determined from the clothing image based on the key points corresponding to the long-sleeved template, and may be used as the clothing key point.

Back projection processing is performed based on the clothing key point and the target clothing template to obtain an initial UV map corresponding to the virtual character.

The clothing is rendered for the virtual character based on the initial UV map to obtain the front-view clothing image corresponding to the virtual character.

The target clothing template may be mapped to a two-dimensional image in advance, and vertex information and a patch identifier of each patch in the target clothing template are recorded to form a mapping relationship. The vertex information of the patch includes a UV coordinate corresponding to each vertex of the patch in a UV map of the target clothing template, and a coordinate of a point corresponding to the vertex in the two-dimensional image. Moreover, the clothing key point corresponds to a clothing key point in the target clothing template one to one, so that a correspondence between each vertex and the patch may be determined based on a correspondence between the key points, and back projection processing is performed in combination with the mapping relationship. For example, a pixel feature of the patch in the clothing image is mapped to a corresponding patch in the UV map of the target clothing template. For each UV pixel in the initial UV map, the UV pixel is drawn based on a pixel value of a pixel corresponding to the UV pixel in the clothing image, to obtain the initial UV map.

Further, rendering may be performed based on the initial UV map, to render the clothing corresponding to the initial UV map for the virtual character, to obtain the front-view clothing image.

In a case that there is no clothing image in the target picture, the front-view clothing image is generated based on the clothing feature prompt information corresponding to the target picture and the target clothing template.

In a case that there is no clothing image in the target picture, image generation may be directly performed based on the clothing feature prompt information, to obtain the front-view clothing image. The clothing feature prompt information is used to represent content features extracted from the target picture. In this embodiment, the content in the target picture may be directly generated to the clothing of the virtual character. For example, the clothing feature prompt information and the target clothing template may be inputted into an image processing model to obtain the front-view clothing image. For example, a corresponding clothing generation area may be determined based on the target clothing template, and the clothing generation area may be used as a control variable to constrain the generation area of the clothing image, which may be represented by a depth map. For example, an identification feature of the clothing generation area may be inputted into a control network (ControlNet) to implement the constraint. Through the constraint, image generation may be performed within an outline range of the target clothing template. In this way, the clothing area may be limited based on the target clothing template, so that the corresponding front-view clothing image is generated in the clothing area.

Therefore, through the above technical solution, image generation may be performed based on the target picture, so that the front-view clothing image consistent with the content of the target picture can be obtained. Moreover, during the process, the initial UV map may be generated through back projection processing by matching the clothing key point, and the clothing image is obtained through rendering the initial UV map, so that the fitness of the determined clothing image rendered on the virtual character can be improved.

In a possible embodiment, an example implementation of the rendering the clothing for the virtual character based on the initial UV map to obtain the front-view clothing image corresponding to the virtual character may include:
rendering the clothing for the virtual character based on the initial UV map to obtain a rendered clothing image. Rendering may be performed based on a general rendering algorithm in the art, which is not limited in the present disclosure.

Then, in a case that there is an occluded area in the rendered clothing image, for a processing pixel in the occluded area, in response to a symmetric pixel of the processing pixel in the rendered clothing image being not in the occluded area, using a pixel value of the symmetric pixel as a pixel value of the processing pixel; or in response to the symmetric pixel of the processing pixel in the rendered clothing image being in the occluded area, determining the pixel value of the processing pixel based on surrounding pixels of the processing pixel.

In a case that there is a clothing image in the target picture, the clothing image may be occluded due to clothing folding or occlusion by other objects, for example, a sleeve part is occluded. For articles of clothing, their designs are usually symmetrical, for example, a left sleeve and a right sleeve are usually symmetrical. Based on this, a combination of symmetric pixels in the rendered clothing image may be preset, where the combination includes two mutually symmetric pixels.

For example, whether there is an occluded area in the rendered clothing image may be determined through an image detection model. The image detection model may be obtained through pre-training, by performing data marking based on images with and without occlusion. In this case, the occluded area in the rendered clothing image may be determined through the image detection model.

Then, each processing pixel in the occluded area may be further traversed to perform completion processing on it. If a symmetric pixel of the processing pixel in the rendered clothing image is not in the occluded area, it indicates that an image in a region where the symmetric pixel is located is complete. In this case, a pixel value of the processing pixel may be determined based on a pixel value of the symmetric pixel, to perform image completion processing based on the symmetric pixel. For example, if a left sleeve has an occluded area and a corresponding region of a right sleeve has a complete image, image completion may be performed on a pixel in the left sleeve through a pixel in the right sleeve.

If the symmetric pixel of the processing pixel in the rendered clothing image is in the occluded area, it indicates that an image in a region where the symmetric pixel is located is also incomplete. In this case, the pixel value of the processing pixel may be determined based on surrounding pixels of the processing pixel. The surrounding pixels may be, for example, four pixels adjacent pixels above, below, to the left, and to the right of the processing pixel, or may be eight pixels surrounding the processing pixel. The surrounding pixels may be set based on an actual application scenario, which is not limited in the present disclosure. For example, an average of pixel values of the surrounding pixels may be used as the pixel value of the processing pixel, thereby achieving image completion. For example, if a left sleeve has an occluded area and a right sleeve also has an occluded area, image completion may be performed based on the surrounding pixels of the left sleeve and the right sleeve respectively.

An image obtained after updating the pixel value of the processing pixel in the rendered clothing image is used as the front-view clothing image.

Therefore, through the above technical solution, the features of the occluded area in the rendered clothing image may be completed, thereby improving the completeness and feature accuracy of the front-view clothing image and providing a more complete image reference for subsequent map generation.

In a possible embodiment, an example implementation of the generating a target clothing image corresponding to the virtual character based on the initial clothing image and the clothing feature prompt information may include:
in a case that there is a clothing image in the target picture, performing a pose detection based on the clothing image to obtain object pose information corresponding to the clothing image; and determining a redrawing proportion based on the object pose information.

The orientation is described with a direction facing the screen being 0 degrees, a counterclockwise rotation direction being a negative value, and a clockwise rotation direction being a positive value. In a case that there is a clothing image in the target picture, and a person pose corresponding to the clothing image is a frontal side of the person, that is, the person pose indicates that an orientation of the person is 0 degrees, most features on a frontal side of the clothing may be displayed. If the orientation indicated by the person pose corresponding to the clothing image is 30 degrees, a front view of the clothing image is partially occluded. Based on this, pose detection may be performed on an object in the target picture, to determine the object pose information corresponding to the clothing image.

The pose detection on the person in the picture may be performed based on a general pose detection manner in the art, for example, object pose information may be obtained by determining information about key points of the object.

For example, different redrawing proportions may be preset for different orientation ranges. For example, a redrawing proportion corresponding to an orientation range [−10°, 10°] is set to 10%, and a redrawing proportion corresponding to an orientation range [−30°, −10°) and (10°, 30°] is set to 20%. Other corresponding configurations will not be described in detail here.

After the object pose information is determined, an orientation of the object may be determined based on positions of key points in the object pose information. Alternatively, the orientation corresponding to the object may be predicted through a pre-trained neural network model based on the object pose information. If an orientation of the object in the target picture determined based on the object pose information is 20°, it may be determined that a corresponding redrawing proportion is 20%.

Then, a target clothing image corresponding to the virtual character is generated based on the redrawing proportion, the initial clothing image, and the clothing feature prompt information.

Accordingly, the redrawing proportion, the initial clothing image, and the clothing feature prompt information may be inputted into an image processing model, so that a new image, that is, the target clothing image, is regenerated based on the image processing model. The redrawing proportion is used to constrain the extent of the adjustment made to the initial clothing image based on the image processing model. If the redrawing proportion is relatively small, the extent of the adjustment made to the initial clothing image based on the clothing feature prompt information is relatively small, and the obtained target clothing image is more similar to the initial clothing image. If the redrawing proportion is relatively large, the extent of the adjustment made to the initial clothing image based on the clothing feature prompt information is relatively large, and the obtained target clothing image has fewer features corresponding to the initial clothing image and more features corresponding to the clothing feature prompt information.

Therefore, through the above technical solution, the extent of the adjustment made to the initial clothing image may be determined based on the object pose information in the target picture. The initial clothing image may be adjusted in combination with the clothing feature prompt information, thereby further improving the accuracy and completeness of the target clothing image.

In a possible embodiment, an example implementation of the determining a target UV map of a target clothing corresponding to the virtual character based on the target clothing image may include:
performing back projection processing based on the target clothing image and a target clothing template corresponding to the virtual character to obtain a first UV map corresponding to the target clothing.

The implementation of this step is similar to the implementation of obtaining the initial UV map corresponding to the virtual character described above, which is not elaborated herein.

As another example, before the back projection processing is performed based on the target clothing image and a target clothing template corresponding to the virtual character, the target clothing image may be adjusted based on mirror initialization. For example, the target clothing image may be segmented to obtain a plurality of image blocks. For each image block, in a case that there is a pixel missing in the current image block, the current image block may be updated with an image block obtained by mirroring an adjacent image block of the image block. The adjacent image block of the image block and a mirroring direction may be pre-configured and selected based on an actual application scenario, which is not limited here. In this way, the target clothing image may be further completed through mirroring, and the completion through mirroring can ensure the image continuity between the current image block and the adjacent image block, thereby avoiding abrupt images. Then back projection processing may be performed based on the completed target clothing image to obtain the first UV map corresponding to the target clothing.

Map completion processing is performed on the first UV map based on a UV map processing model to obtain a second UV map corresponding to the target clothing.

For example, a training UV map for model training may be collected in advance, and training data may be constructed based on the training UV map and a mask. For example, there may be defects at a boundary of a UV map of a clothing image. In this case, the boundary of the training UV map may be masked through the mask to obtain a missing UV map. Then, the missing UV map may be used as input data of the UV map processing model, and the training UV map may be used as a target output of the model, to train the UV map processing model. In this way, the trained UV map training model can predict and complete the missing UV map to obtain a complete UV map. Accordingly, in this embodiment, the first UV map may be inputted into the UV map processing model, so that a complete second UV map is predicted and obtained based on the model.

A target UV map of the target clothing is generated based on the second UV map.

For example, the second UV map may be directly used as the target UV map of the target clothing. As another example, super-resolution processing may be performed on the second UV map to obtain the target UV map of the target clothing. The processing may be performed based on a general super-resolution algorithm in the art, which is not limited in the present disclosure.

Therefore, through the above technical solution, the target UV map of the target clothing may be generated based on the target clothing image. In addition, during the process of generating the target UV map, the UV map may be further completed through prediction of the UV map processing model, thereby improving the completeness of the generated target UV map, ensuring the structural consistency between the target UV map and an existing clothing map, and ensuring the display clarity of the target clothing obtained through rendering to a certain extent, thereby improving the user experience.

In a possible embodiment, before the determining a target UV map of a target clothing corresponding to the virtual character based on the target clothing image, the method may further include:
outputting the target clothing image. The target clothing image may be displayed to the user through a display interface, so that the user can preview a result of rendering the generated target clothing on the virtual character based on the target clothing image.

In response to receiving an image adjustment message, image generation is performed based on an adjustment parameter indicated by the image adjustment message, the target clothing image, and the clothing feature prompt information to obtain a new target clothing image that is regenerated, where the adjustment parameter includes a redrawing proportion and/or a redrawing area.

For example, after browsing the target clothing image, the user may want to modify the target clothing image. For example, if the user has a clear idea of which part needs to be modified, in this scenario, the user may select an area on the display interface, for example, select a partial area through a rectangular box or a circular box, and the partial area may be used as the redrawing area. As another example, if the user has no clear idea of which part needs to be modified, in this scenario, the user may input the redrawing proportion to determine a proportion of the target clothing image that the user wants to adjust.

Accordingly, the image adjustment message may be triggered based on a processing operation of the user. If the adjustment parameter is the redrawing area, a corresponding region may be determined from the target clothing image based on the redrawing area, and the area is marked with pixels. The pixel marking may be filling pixel values in the region with a marking value to indicate that the pixels in the area need to be modified. Then, image generation is performed based on the target clothing image obtained after the pixel marking, and the clothing feature prompt information, to obtain the new target clothing image that is regenerated. If the adjustment parameter is the redrawing proportion, image generation may be performed based on the redrawing proportion, the target clothing image, and the clothing feature prompt information, to obtain the new target clothing image that is regenerated. The implementation manner has been described in detail above.

The new target clothing image that is regenerated may be output and displayed again. If the user still wants to modify the new target clothing image, the above process may be repeated until the user is satisfied with the target clothing image. Then subsequent UV map generation may be performed based on the target clothing image.

Therefore, through the above technical solution, the preview image of the target clothing obtained by rendering the virtual character based on the target picture may be promptly displayed to the user, ensuring the accuracy of the target clothing image corresponding to subsequent UV map generation. In addition, the user is supported to modify the generated target clothing image, so that the user's satisfaction with the target clothing image can be further improved, thereby improving the satisfaction of the finally generated target clothing, improving the matching degree between the generated UV map and the user requirements, and increasing the diversity of interaction during the clothing generation process.

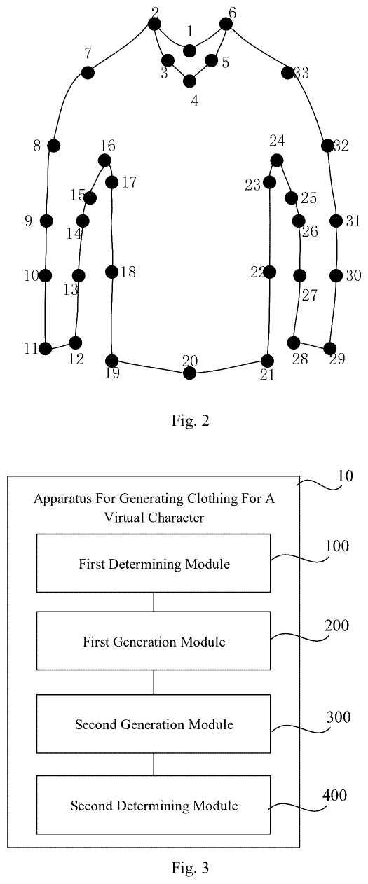

Based on the same inventive concept, the present disclosure further provides an apparatus for generating clothing for a virtual character. As shown in FIG. 3, the apparatus 10 includes:
a first determining module 100, configured to receive a target picture, and determine clothing feature prompt information corresponding to the target picture;
a first generation module 200, configured to generate an initial clothing image corresponding to a virtual character based on the target picture;
a second generation module 300, configured to generate a target clothing image corresponding to the virtual character based on the initial clothing image and the clothing feature prompt information; and
a second determining module 400, configured to determine a target UV map of a target clothing corresponding to the virtual character based on the target clothing image, where the target UV map is used to render the clothing for the virtual character.

Optionally, the first determining module includes:
a first determining submodule, configured to detect the target picture to determine a clothing detection result corresponding to the target picture, where the clothing detection result includes a clothing detection box in the target picture and a clothing attribute; and
a first generation submodule, configured to generate a prompt corresponding to the target picture based on the clothing detection result and the target picture, and generate the clothing feature prompt information based on the prompt.

Optionally, the first generation submodule includes:
an extraction submodule, configured to perform feature extraction on the target picture based on a clothing description model to obtain a clothing description text corresponding to the target picture;
a second determining submodule, configured to, based on the clothing description text and a preset clothing feature dimension, determine a prompt corresponding to each clothing feature dimension, where the clothing feature dimension includes the clothing attribute; and
an updating submodule, configured to, in response to a confidence level corresponding to the clothing attribute in the clothing detection result being greater than or equal to a confidence level threshold, update a prompt corresponding to the clothing attribute to an attribute value of the clothing attribute in the clothing detection result.

Optionally, the first generation module includes:
a second generation submodule, configured to generate a front-view clothing image corresponding to the virtual character based on the target picture and a target clothing template corresponding to the virtual character; and
a third generation submodule, configured to generate a back-view clothing image corresponding to the virtual character based on the front-view clothing image and a preset image generation model, where the initial clothing image includes the front-view clothing image and the back-view clothing image.

Optionally, the second generation submodule includes:
a first detection submodule, configured to perform a clothing key point detection based on the target clothing template and the target picture to determine a clothing key point corresponding to the clothing image in a case that there is a clothing image in the target picture;
a first processing submodule, configured to perform back projection processing based on the clothing key point and the target clothing template to obtain an initial UV map corresponding to the virtual character;
a first rendering submodule, configured to render the clothing for the virtual character based on the initial UV map to obtain the front-view clothing image corresponding to the virtual character; and
a fourth generation submodule, configured to generate the front-view clothing image based on the clothing feature prompt information corresponding to the target picture and the target clothing template in a case that there is no clothing image in the target picture.

Optionally, the first rendering submodule includes:
a second rendering submodule, configured to render the clothing for the virtual character based on the initial UV map to obtain a rendered clothing image;
a second processing submodule, configured to determine, for a processing pixel in an occluded area, in response to a symmetric pixel of the processing pixel in the rendered clothing image being not in the occluded area, use a pixel value of the symmetric pixel as a pixel value of the processing pixel; or in response to the symmetric pixel of the processing pixel in the rendered clothing image being in the occluded area, determine the pixel value of the processing pixel based on surrounding pixels of the processing pixel in a case that there is an occluded area in the rendered clothing image; and
a third determining submodule, configured to use an image obtained after updating the pixel value of the processing pixel in the rendered clothing image as the front-view clothing image.

Optionally, the second generation module includes:
a second detection submodule, configured to perform a pose detection based on the clothing image to obtain object pose information corresponding to the clothing image in a case that there is a clothing image in the target picture;
a fourth determining submodule, configured to determine a redrawing proportion based on the object pose information; and
a fifth generation submodule, configured to generate a target clothing image corresponding to the virtual character based on the redrawing proportion, the initial clothing image, and the clothing feature prompt information.

Optionally, the second determining module includes:
a third processing submodule, configured to perform back projection processing based on the target clothing image and a target clothing template corresponding to the virtual character to obtain a first UV map corresponding to the target clothing;
a fourth processing submodule, configured to perform map completion processing on the first UV map based on a UV map processing model to obtain a second UV map corresponding to the target clothing; and
a sixth generation submodule, configured to generate a target UV map of the target clothing based on the second UV map.

Optionally, the apparatus further includes:
an output module, configured to output the target clothing image before the second determining module determines a target UV map of a target clothing corresponding to the virtual character based on the target clothing image; and
a third generation module, configured to, in response to receiving an image adjustment message, perform image generation based on an adjustment parameter indicated by the image adjustment message, the target clothing image, and the clothing feature prompt information to obtain a new target clothing image that is regenerated, where the adjustment parameter includes a redrawing proportion and/or a redrawing area.

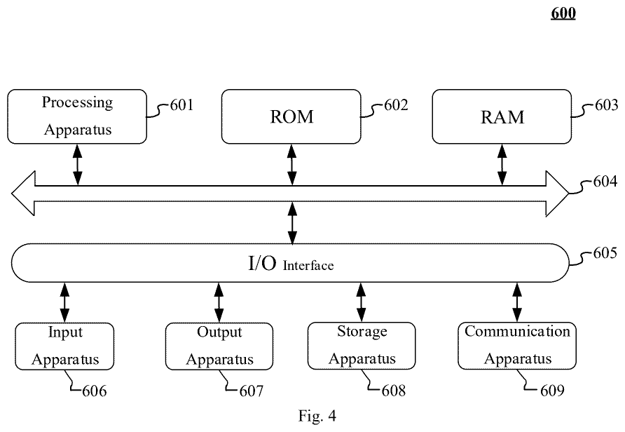

Reference is made to FIG. 4 below, which is a structural schematic diagram of an electronic device (for example, a terminal device or a server) 600 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal) or the like, and fixed terminals such as a digital TV, a desktop computer or the like. The electronic device shown in FIG. 4 is merely an example, and shall not impose any limitation on the function and scope of use of the embodiments of the present disclosure.

As shown in FIG. 4, the electronic device 600 may include a processing apparatus (for example, a central processing unit, a graphics processing unit, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 4 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above-mentioned functions defined in the method of the embodiment of the present disclosure are performed.

It should be noted that the above-mentioned computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to electric wires, optical cables, radio frequency (RF), and the like, or any suitable combination thereof.

In some implementations, the client and the server may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The computer-readable medium described above may be contained in the above electronic device. Alternatively, the computer-readable medium may exist independently, without being assembled into the electronic device.

The computer-readable medium carries one or more programs, which, when executed by the electronic device, cause the electronic device to: receive a target picture, and determine clothing feature prompt information corresponding to the target picture; generate an initial clothing image corresponding to a virtual character based on the target picture; generate a target clothing image corresponding to the virtual character based on the initial clothing image and the clothing feature prompt information; and determine a target UV map of a target clothing corresponding to the virtual character based on the target clothing image, where the target UV map is used to render the clothing for the virtual character.

The computer program code for performing operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments described in the present disclosure may be implemented by software, or may be implemented by hardware. The name of a module does not constitute a limitation on the module in some cases. For example, the first determining module may alternatively be described as “a module that receives a target picture, and determines clothing feature prompt information corresponding to the target picture”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a method for generating clothing for a virtual character, where the method includes:
receiving a target picture, and determining clothing feature prompt information corresponding to the target picture;
generating an initial clothing image corresponding to a virtual character based on the target picture;
generating a target clothing image corresponding to the virtual character based on the initial clothing image and the clothing feature prompt information; and
determining a target UV map of a target clothing corresponding to the virtual character based on the target clothing image, where the target UV map is used to render the clothing for the virtual character.

According to one or more embodiments of the present disclosure, Example 2 provides the method of Example 1, where the determining clothing feature prompt information corresponding to the target picture includes:
detecting the target picture to determine a clothing detection result corresponding to the target picture, where the clothing detection result includes a clothing detection box in the target picture and a clothing attribute; and
generating a prompt corresponding to the target picture based on the clothing detection result and the target picture, and generating the clothing feature prompt information based on the prompt.

According to one or more embodiments of the present disclosure, Example 3 provides the method of Example 2, where the generating a prompt corresponding to the target picture based on the clothing detection result and the target picture includes:
performing feature extraction on the target picture based on a clothing description model to obtain a clothing description text corresponding to the target picture;
based on the clothing description text and a preset clothing feature dimension, determining a prompt corresponding to each clothing feature dimension, where the clothing feature dimension includes the clothing attribute; and
in response to a confidence level corresponding to the clothing attribute in the clothing detection result being greater than or equal to a confidence level threshold, updating a prompt corresponding to the clothing attribute to an attribute value of the clothing attribute in the clothing detection result.

According to one or more embodiments of the present disclosure, Example 4 provides the method of Example 1, where the generating an initial clothing image corresponding to a virtual character based on the target picture includes:
generating a front-view clothing image corresponding to the virtual character based on the target picture and a target clothing template corresponding to the virtual character; and
generating a back-view clothing image corresponding to the virtual character based on the front-view clothing image and a preset image generation model, where the initial clothing image includes the front-view clothing image and the back-view clothing image.

According to one or more embodiments of the present disclosure, Example 5 provides the method of Example 4, where the generating a front-view clothing image corresponding to the virtual character based on the target picture and a target clothing template corresponding to the virtual character includes:
performing a clothing key point detection based on the target clothing template and the target picture to determine a clothing key point corresponding to the clothing image in a case that there is a clothing image in the target picture;
performing back projection processing based on the clothing key point and the target clothing template to obtain an initial UV map corresponding to the virtual character;
rendering the clothing for the virtual character based on the initial UV map to obtain the front-view clothing image corresponding to the virtual character; and
generating the front-view clothing image based on the clothing feature prompt information corresponding to the target picture and the target clothing template in a case that there is no clothing image in the target picture.

According to one or more embodiments of the present disclosure, Example 6 provides the method of Example 5, where the rendering the clothing for the virtual character based on the initial UV map to obtain the front-view clothing image corresponding to the virtual character includes:
rendering the clothing for the virtual character based on the initial UV map to obtain a rendered clothing image;
determining, for a processing pixel in an occluded area, in response to a symmetric pixel of the processing pixel in the rendered clothing image being not in the occluded area, use a pixel value of the symmetric pixel as a pixel value of the processing pixel; or in response to the symmetric pixel of the processing pixel in the rendered clothing image being in the occluded area, determine the pixel value of the processing pixel based on surrounding pixels of the processing pixel in a case that there is an occluded area in the rendered clothing image; and
using an image obtained after updating the pixel value of the processing pixel in the rendered clothing image as the front-view clothing image.

According to one or more embodiments of the present disclosure, Example 7 provides the method of Example 1, where the generating a target clothing image corresponding to the virtual character based on the initial clothing image and the clothing feature prompt information includes:
performing a pose detection based on the clothing image to obtain object pose information corresponding to the clothing image in a case that there is a clothing image in the target picture;
determining a redrawing proportion based on the object pose information; and
generating a target clothing image corresponding to the virtual character based on the redrawing proportion, the initial clothing image, and the clothing feature prompt information.

According to one or more embodiments of the present disclosure, Example 8 provides the method of Example 1, where the determining a target UV map of a target clothing corresponding to the virtual character based on the target clothing image includes:
performing back projection processing based on the target clothing image and a target clothing template corresponding to the virtual character to obtain a first UV map corresponding to the target clothing;
performing map completion processing on the first UV map based on a UV map processing model to obtain a second UV map corresponding to the target clothing; and
generating a target UV map of the target clothing based on the second UV map.

According to one or more embodiments of the present disclosure, Example 9 provides the method of Example 1, where before the determining a target UV map of a target clothing corresponding to the virtual character based on the target clothing image, the method further includes:
outputting the target clothing image; and
in response to receiving an image adjustment message, performing image generation based on an adjustment parameter indicated by the image adjustment message, the target clothing image, and the clothing feature prompt information to obtain a new target clothing image that is regenerated, where the adjustment parameter includes a redrawing proportion and/or a redrawing area.

According to one or more embodiments of the present disclosure, Example 10 provides an apparatus for generating clothing for a virtual character, where the apparatus includes:
a first determining module, configured to receive a target picture, and determine clothing feature prompt information corresponding to the target picture;
a first generation module, configured to generate an initial clothing image corresponding to a virtual character based on the target picture;
a second generation module, configured to generate a target clothing image corresponding to the virtual character based on the initial clothing image and the clothing feature prompt information; and
a second determining module, configured to determine a target UV map of a target clothing corresponding to the virtual character based on the target clothing image, where the target UV map is used to render the clothing for the virtual character.

According to one or more embodiments of the present disclosure, Example 11 provides a computer-readable medium having a computer program stored thereon, where when the program is executed by a processor, the steps of the method according to any one of Examples 1 to 9 are implemented.

According to one or more embodiments of the present disclosure, Example 12 provides an electronic device, including:
a memory having a computer program stored thereon; and
a processor configured to execute the computer program in the memory to implement the steps of the method according to any one of Examples 1 to 9.

The above descriptions are merely preferred embodiments of the present disclosure and explanations of the applied technical principles. Persons skilled in the art should understand that the scope of disclosure involved in the present disclosure is not limited to the technical solutions formed by specific combinations of the above technical features, and shall also cover other technical solutions formed by any combination of the above technical features or equivalent features thereof without departing from the above concept of disclosure. For example, the technical solutions formed by replacing the above features with technical features with similar functions disclosed in the present disclosure.

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are included in the above discussions, these details should not be construed as limiting the scope of the present disclosure. Some features that are described in the context of separate embodiments may alternatively be implemented in combination in a single embodiment. In contrast, various features described in a single embodiment may alternatively be implemented in a plurality of embodiments individually or in any suitable sub-combination.

Although the subject matter has been described in a language specific to structural features and/or logical actions of the method, it should be understood that the subject matter specified in the appended claims is not necessarily limited to the specific features or actions described above. In contrast, the specific features and actions described above are merely exemplary forms of implementing the claims. For the apparatus in the above embodiments, the specific manner in which each module performs an operation has been described in detail in the embodiments related to the method, and will not be detailed here.

1. A method for generating clothing for a virtual character, comprising:
receiving a target picture, and determining clothing feature prompt information corresponding to the target picture;
generating an initial clothing image corresponding to the virtual character based on the target picture;
generating a target clothing image corresponding to the virtual character based on the initial clothing image and the clothing feature prompt information; and
determining a target UV map of a target clothing corresponding to the virtual character based on the target clothing image, wherein the target UV map is used to render the clothing for the virtual character.

2. The method according to claim 1, wherein the determining clothing feature prompt information corresponding to the target picture comprises:
detecting the target picture to determine a clothing detection result corresponding to the target picture, wherein the clothing detection result comprises a clothing detection box in the target picture and a clothing attribute; and
generating a prompt corresponding to the target picture based on the clothing detection result and the target picture, and generating the clothing feature prompt information based on the prompt.

3. The method according to claim 2, wherein the generating the prompt corresponding to the target picture based on the clothing detection result and the target picture comprises:
performing feature extraction on the target picture based on a clothing description model to obtain a clothing description text corresponding to the target picture;
based on the clothing description text and a preset clothing feature dimension, determining a prompt corresponding to each clothing feature dimension, wherein the clothing feature dimension comprises the clothing attribute; and
in response to a confidence level corresponding to the clothing attribute in the clothing detection result being greater than or equal to a confidence level threshold, updating a prompt corresponding to the clothing attribute to an attribute value of the clothing attribute in the clothing detection result.

4. The method according to claim 1, wherein the generating the initial clothing image corresponding to the virtual character based on the target picture comprises:
generating a front-view clothing image corresponding to the virtual character based on the target picture and a target clothing template corresponding to the virtual character; and
generating a back-view clothing image corresponding to the virtual character based on the front-view clothing image and a preset image generation model, wherein the initial clothing image comprises the front-view clothing image and the back-view clothing image.

5. The method according to claim 4, wherein the generating the front-view clothing image corresponding to the virtual character based on the target picture and the target clothing template corresponding to the virtual character comprises:
in a case that there is a clothing image in the target picture, performing a clothing key point detection based on the target clothing template and the target picture to determine a clothing key point corresponding to the clothing image;
performing back projection processing based on the clothing key point and the target clothing template to obtain an initial UV map corresponding to the virtual character;
rendering the clothing for the virtual character based on the initial UV map to obtain the front-view clothing image corresponding to the virtual character; or
in a case that there is no clothing image in the target picture, generating the front-view clothing image based on the clothing feature prompt information corresponding to the target picture and the target clothing template.

6. The method according to claim 5, wherein the rendering the clothing for the virtual character based on the initial UV map to obtain the front-view clothing image corresponding to the virtual character comprises:
rendering the clothing for the virtual character based on the initial UV map to obtain a rendered clothing image;
in a case that there is an occluded area in the rendered clothing image, for a processing pixel in the occluded area, in response to a symmetric pixel of the processing pixel in the rendered clothing image being not in the occluded area, using a pixel value of the symmetric pixel as a pixel value of the processing pixel; or in response to the symmetric pixel of the processing pixel in the rendered clothing image being in the occluded area, determining the pixel value of the processing pixel based on surrounding pixels of the processing pixel; and
using an image obtained after updating the pixel value of the processing pixel in the rendered clothing image as the front-view clothing image.

7. The method according to claim 1, wherein the generating the target clothing image corresponding to the virtual character based on the initial clothing image and the clothing feature prompt information comprises:
in a case that there is a clothing image in the target picture, performing a pose detection based on the clothing image to obtain object pose information corresponding to the clothing image;
determining a redrawing proportion based on the object pose information; and
generating the target clothing image corresponding to the virtual character based on the redrawing proportion, the initial clothing image, and the clothing feature prompt information.

8. The method according to claim 1, wherein the determining the target UV map of the target clothing corresponding to the virtual character based on the target clothing image comprises:
performing back projection processing based on the target clothing image and a target clothing template corresponding to the virtual character to obtain a first UV map corresponding to the target clothing;
performing map completion processing on the first UV map based on a UV map processing model to obtain a second UV map corresponding to the target clothing; and
generating the target UV map of the target clothing based on the second UV map.

9. The method according to claim 1, wherein before the determining the target UV map of the target clothing corresponding to the virtual character based on the target clothing image, the method further comprises:
outputting the target clothing image; and
in response to receiving an image adjustment message, performing image generation based on an adjustment parameter indicated by the image adjustment message, the target clothing image, and the clothing feature prompt information to obtain a new target clothing image that is regenerated, wherein the adjustment parameter comprises a redrawing proportion and/or a redrawing area.

10. A non-transitory computer-readable medium having stored thereon a computer program, wherein the program upon executed by a processor, cause the processor to implement a method for generating clothing for a virtual character, which comprises:
receiving a target picture, and determining clothing feature prompt information corresponding to the target picture;
generating an initial clothing image corresponding to the virtual character based on the target picture;
generating a target clothing image corresponding to the virtual character based on the initial clothing image and the clothing feature prompt information; and
determining a target UV map of a target clothing corresponding to the virtual character based on the target clothing image, wherein the target UV map is used to render the clothing for the virtual character.

11. The medium according to claim 10, wherein the determining clothing feature prompt information corresponding to the target picture comprises:
detecting the target picture to determine a clothing detection result corresponding to the target picture, wherein the clothing detection result comprises a clothing detection box in the target picture and a clothing attribute; and
generating a prompt corresponding to the target picture based on the clothing detection result and the target picture, and generating the clothing feature prompt information based on the prompt.

12. The medium according to claim 11, wherein the generating the prompt corresponding to the target picture based on the clothing detection result and the target picture comprises:
performing feature extraction on the target picture based on a clothing description model to obtain a clothing description text corresponding to the target picture;
based on the clothing description text and a preset clothing feature dimension, determining a prompt corresponding to each clothing feature dimension, wherein the clothing feature dimension comprises the clothing attribute; and
in response to a confidence level corresponding to the clothing attribute in the clothing detection result being greater than or equal to a confidence level threshold, updating a prompt corresponding to the clothing attribute to an attribute value of the clothing attribute in the clothing detection result.

13. The medium according to claim 10, wherein the generating the initial clothing image corresponding to the virtual character based on the target picture comprises:
generating a front-view clothing image corresponding to the virtual character based on the target picture and a target clothing template corresponding to the virtual character; and
generating a back-view clothing image corresponding to the virtual character based on the front-view clothing image and a preset image generation model, wherein the initial clothing image comprises the front-view clothing image and the back-view clothing image.

14. The medium according to claim 13, wherein the generating the front-view clothing image corresponding to the virtual character based on the target picture and the target clothing template corresponding to the virtual character comprises:
in a case that there is a clothing image in the target picture, performing a clothing key point detection based on the target clothing template and the target picture to determine a clothing key point corresponding to the clothing image;
performing back projection processing based on the clothing key point and the target clothing template to obtain an initial UV map corresponding to the virtual character;
rendering the clothing for the virtual character based on the initial UV map to obtain the front-view clothing image corresponding to the virtual character; or
in a case that there is no clothing image in the target picture, generating the front-view clothing image based on the clothing feature prompt information corresponding to the target picture and the target clothing template.

15. The medium according to claim 14, wherein the rendering the clothing for the virtual character based on the initial UV map to obtain the front-view clothing image corresponding to the virtual character comprises:
rendering the clothing for the virtual character based on the initial UV map to obtain a rendered clothing image;
in a case that there is an occluded area in the rendered clothing image, for a processing pixel in the occluded area, in response to a symmetric pixel of the processing pixel in the rendered clothing image being not in the occluded area, using a pixel value of the symmetric pixel as a pixel value of the processing pixel; or in response to the symmetric pixel of the processing pixel in the rendered clothing image being in the occluded area, determining the pixel value of the processing pixel based on surrounding pixels of the processing pixel; and
using an image obtained after updating the pixel value of the processing pixel in the rendered clothing image as the front-view clothing image.

16. The medium according to claim 10, wherein the generating the target clothing image corresponding to the virtual character based on the initial clothing image and the clothing feature prompt information comprises:
in a case that there is a clothing image in the target picture, performing a pose detection based on the clothing image to obtain object pose information corresponding to the clothing image;
determining a redrawing proportion based on the object pose information; and
generating the target clothing image corresponding to the virtual character based on the redrawing proportion, the initial clothing image, and the clothing feature prompt information.

17. The medium according to claim 10, wherein the determining the target UV map of the target clothing corresponding to the virtual character based on the target clothing image comprises:
performing back projection processing based on the target clothing image and a target clothing template corresponding to the virtual character to obtain a first UV map corresponding to the target clothing;
performing map completion processing on the first UV map based on a UV map processing model to obtain a second UV map corresponding to the target clothing; and
generating the target UV map of the target clothing based on the second UV map.

18. The medium according to claim 10, wherein before the determining the target UV map of the target clothing corresponding to the virtual character based on the target clothing image, the method further comprises:
outputting the target clothing image; and
in response to receiving an image adjustment message, performing image generation based on an adjustment parameter indicated by the image adjustment message, the target clothing image, and the clothing feature prompt information to obtain a new target clothing image that is regenerated, wherein the adjustment parameter comprises a redrawing proportion and/or a redrawing area.

19. An electronic device, comprising:
a memory having stored thereon a computer program; and
a processor, configured to execute the computer program in the memory to implement a method for generating clothing for a virtual character, which comprises:
receiving a target picture, and determining clothing feature prompt information corresponding to the target picture;
generating an initial clothing image corresponding to the virtual character based on the target picture;
generating a target clothing image corresponding to the virtual character based on the initial clothing image and the clothing feature prompt information; and
determining a target UV map of a target clothing corresponding to the virtual character based on the target clothing image, wherein the target UV map is used to render the clothing for the virtual character.

20. The electronic device according to claim 19, wherein the determining clothing feature prompt information corresponding to the target picture comprises:
detecting the target picture to determine a clothing detection result corresponding to the target picture, wherein the clothing detection result comprises a clothing detection box in the target picture and a clothing attribute; and
generating a prompt corresponding to the target picture based on the clothing detection result and the target picture, and generating the clothing feature prompt information based on the prompt.
